(19) United States
(12) Patent Application Publication
(10) Pub. No.: US 2026/0180737 A1
(43) Pub. Date: Jun. 25, 2026

(54) MAC LAYER TCI ACTIVATION FOR MULTI-RX UE

(71) Applicant: Apple Inc., Cupertino, CA (US)

(72) Inventors: Jie Cui, San Jose, CA (US); Yang Tang, San Jose, CA (US); Haitong Sun, Cupertino, CA (US); Xiang Chen, Campbell, CA (US); Dawei Zhang, Saratoga, CA (US); Chunxuan Ye, San Diego, CA (US); Qiming Li, Beijing (CN)

(21) Appl. No.: 18/837,542

(22) PCT Filed: Aug. 10, 2023
(86) PCT No.: PCT/CN2023/112285

§ 371 Date: Aug. 9, 2024

(51) Int. Cl. H04L 5/00

(52) U.S. Cl. CPC H04L 5/0048

(57) ABSTRACT

A user equipment includes a first antenna panel; a second antenna panel; a set of one or more transceivers configured to transmit and receive over the air using at least one of the first antenna panel or the second antenna panel; and a processor. The processor is configured to receive at least one Medium Access Control (MAC) Control Element (CE) (MAC-CE) that triggers a dual Transmission Configuration Indicator (TCI) activation associated with the first and second antenna panels; decode the MAC-CE; for a predetermined period of time, use a current TCI to receive over the air using at least the first antenna panel or the second antenna panel; and after the predetermined period of time, switch to a dual TCI activated by the dual TCI activation, the dual TCI used by the UE to receive, over the air, using the first and second antenna panels.

### TECHNICAL FIELD

This application relates generally to wireless communication systems, including wireless communication systems in which a wireless communications device (e.g., a user equipment (UE)) has two or more antenna panels that are each capable of receiving a signal from a network (e.g., a first signal from a first transmission and reception point (TRP) of a 3rd Generation Partnership Project (3GPP) network, and a second signal from a second TRP of a 3GPP network). Each signal may be received on a respective receive (Rx) beam formed by a respective one of the antenna panels. The signals may be received on the respective Rx beams, from the respective TRPs, contemporaneously (e.g., simultaneously or within overlapping periods of time) or sequentially (e.g., one after another or in a time domain multiplexed (TDM) manner). A UE that is capable of receiving first and second signals, via first and second antenna panels may be referred to herein as a multi-Rx UE.

### BACKGROUND

Wireless mobile communication technology uses various standards and protocols to transmit data between a network device (e.g., a base station, a radio head, etc.) and a wireless communication device. Wireless communication system standards and protocols can include, for example, 3GPP long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a network device of the RAN (which may also sometimes be referred to generally as a RAN node, a network node, or simply a node) and a wireless communication device known as a UE. 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the network device and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A network device used by a RAN may correspond to that RAN, One example of an E-UTRAN network device is an Evolved Universal Terrestrial Radio Access Network (E-UTRAN) Node B (also commonly denoted as evolved Node B, enhanced Node B, eNodeB, or eNB). One example of an NG-RAN network device is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 shows an example multi-Rx UE having multiple antenna panels, according to embodiments described herein.

FIG. 2 shows an example wireless communication system, according to embodiments described herein

FIGS. 3-5 show example methods of wireless communication by a UE, according to embodiments described herein.

FIG. 6 illustrates an example architecture of a wireless communication system, according to embodiments described herein.

FIG. 7 illustrates an example system for performing signaling between a wireless device and a network device, according to embodiments described herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with a network. Therefore, the UE as described herein is used to represent any appropriate electronic device.

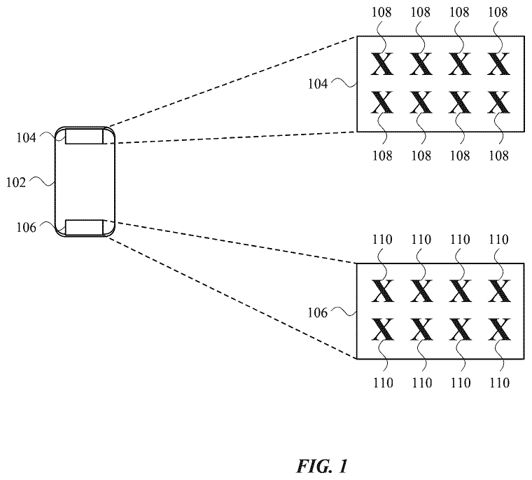

FIG. 1 shows an example multi-Rx UE 102 having multiple antenna panels (e.g., first and second antenna panels 104, 106). Each antenna panel 104, 106 may have a set of multiple antenna ports 108, 110. The antenna ports 108, 110 of a particular antenna panel 104, 106 may be tuned to form a respective Rx beam for the antenna panel (104 or 106). Each Rx beam may be used to receive on a downlink (DL), at the UE 102, from a respective TRP. Each TRP may be associated with the same cell, or different TRPs may be associated with different cells.

A first antenna panel 104 may include a first set of antenna ports 108 that correspond to a first Rx chain. A second antenna panel 106 may include a second set of antenna ports 110 that correspond to a second Rx chain. The different antenna panels 104, 106 may be used to receive DL transmissions having different angles of arrival (AoA).

In some embodiments, a UE may operate in a multiple Rx chain configuration, and may communicate with one or TRPs simultaneously (e.g., one or more TRPs of a RAN), using the antenna ports 108, 110 of one or both antenna panels 104, 106.

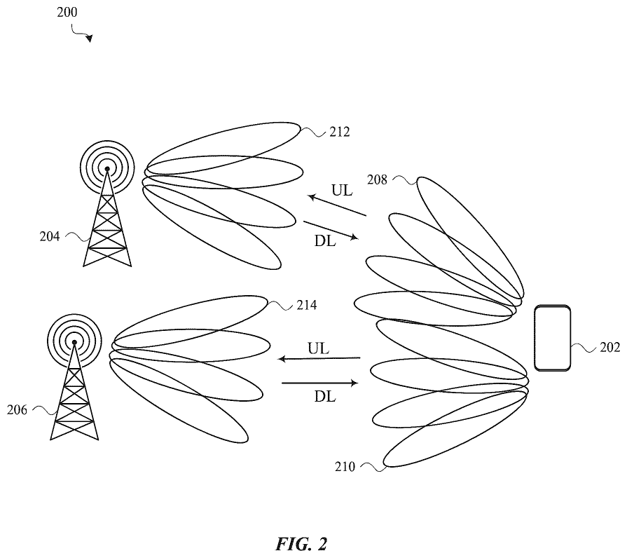

FIG. 2 shows an example wireless communications system 200. The wireless communications system 200 may include a UE 202 that may connect, over the air, to one or more TRPs 204, 206 of a network (e.g., a 3GPP network). In some embodiments, the UE 202 may be the multi-Rx UE described with reference to FIG. 1, or another UE described herein. The UE 202 may communicate with the network on one or more uplink (UL) channels and one or more DL channels, and more particularly may communicate with one or more network devices or TRPs (e.g., TRP 204 and/or TRP 206, which may take the form of one or more base stations (e.g., gNBs), remote radio heads, etc. of one or more cells) on the one or more UL channels and DL channels. Depending on the capabilities of the UE 202 and the UE's configuration by the network, the UE 202 may communicate with the one or more TRPs 204, 206 contemporaneously (e.g., simultaneously) or sequentially.

The UE 202 may communicate with each TRP 204, 206 on one or more beams 208, 210 (e.g., Rx beams or transmit (Tx) beams) formed by one or more antenna panels. Similarly, each TRP 204, 206 may communicate with the UE 202 on one or more beams 212, 214. For beam selection and radio resource management (RRM) purposes, the UE 202 may measure one or more signals (e.g., one or more Synchronization Signal Blocks (SSBs) and/or Channel State Information (CSI) Reference Signals (RSs) (CSI-RSs) transmitted by or for the first and second TRPs 204, 206.

In some cases, a network may configure a UE with one or more Transmission Configuration Indicator (TCI) states and also activate one or more TCI states. A TCI state contains parameters for configuring a quasi co-location (QCL) relationship between one or more DL reference signals and one or more antenna ports. An activated TCI state is a TCI state that the network wants a UE to use. From time-to-time, a network may cause a UE to switch between TCI states, or to use one or multiple TCI states (e.g., in the case of a multi-Rx UE).

In some cases, a UE may receive a Medium Access Control (MAC) Control Element (CE) (MAC-CE) that triggers a TCI activation (i.e., a MAC layer TCI activation), In the case of a multi-Rx UE, the UE may receive a MAC-CE that triggers a TCI activation associated with one antenna panel of the UE (e.g., a first antenna panel or a second antenna panel), or the UE may receive a MAC-CE that triggers a TCI activation associated with more than one antenna panel of the UE (e.g., a first antenna panel and a second antenna panel).

For a UE that receives a MAC layer TCI activation of a dual TCI (i.e., a TCI that activates a TCI state for each of first and second antenna panels of the UE, there is an unresolved issue regarding how long the UE should continue to use its current (or soon to be previous) TCI.

Another issue is whether UE behavior for an unknown target TCI state needs to be defined. For example, if a MAC-CE that triggers a TCI activation associated with more than one antenna panel is allowed to reference an unknown target TCI state (i.e., a target TCI state for which a UE has never performed measurements, or a target TCI state for which a UE has performed measurements but the measurements are out-of-date), it is currently unclear how the UE should perform Layer 1 (L1) Reference Signal Received Power (RSRP) (L1-RSRP) measurements for the unknown target TCI state, and then subsequently use the L1-RSRP measurements to identify a set of Rx beams for receiving from a set of TRPs. It is also unclear what kind of switching delay would be needed to perform the L1-RSRP measurements.

When a UE receives a MAC-CE that triggers a TCI activation associated with more than one antenna panel, a further unresolved issue pertains to what reference signal(s) the UE should use for time and frequency tracking before a dual TCI switch (e.g., because there are two TRPs, and the UE may receive different reference signals from different TRPs).

In regard to when a UE should switch to a TCI triggered by a TCI activation, or how long a UE should continue to use its current TCI before switching to the TCI triggered by a TCI activation, 3GPP Technical Specification (TS) 38.133, Section 8.10.3 V18.2.0 (2023-06) states that:
If the target TCI state is known, upon receiving PDSCH carrying MAC-CE activation command in slot n, UE shall be able to receive PDCCH with target TCI state of the serving cell on which TCI state switch occurs at the first slot that is after

$$slot n + {T}_{HARQ} + 3 {N}_{slot}^{subframe , μ} + {TO}_{k} * ( {T}_{first - SSB} + {T}_{SSB - proc} ) / NR slot length .$$

The UE shall be able to receive PDCCH with the old TCI state until

$$slot n + {T}_{HARQ} + 3 {N}_{slot}^{subframe , μ} .$$

where T_{HARQ} is the timing between DL data transmission and acknowledgement as specified in TS 38.213 . . . .

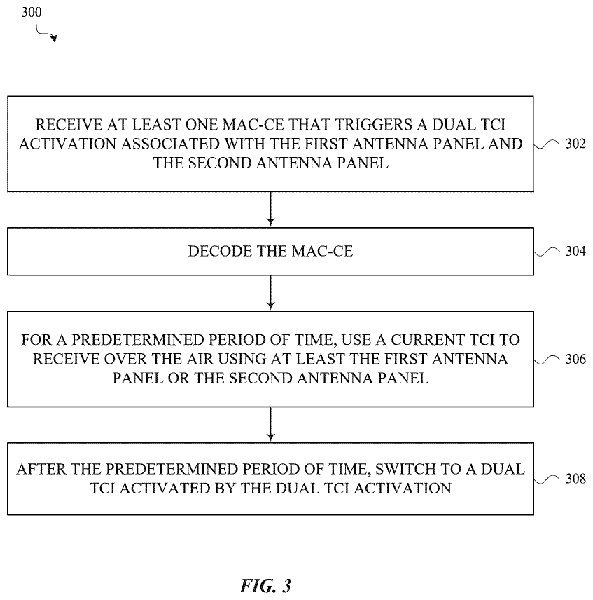

However, this presumes that a single TCI is triggered by a single TCI activation (i.e., for a single TRP). The UE behavior after a MAC-CE triggers a dual TCI activation, associated with first and second antenna panels of the UE, is not defined. In this regard, FIG. 3 shows an example method 300 of wireless communication by a UE. In some cases, the UE may be the UE described with reference to FIG. 1 or 2 or one of the other UEs described herein. The method 300 may be performed using a processor, a set of one or more transceivers, and/or other components of the UE. The set of one or more transceivers may be configured to transmit and receive over the air using at least one of a first antenna panel of the UE or a second antenna panel of the UE.

At 302, the method 300 may include receiving (e.g., from a network, such as a RAN) at least one MAC-CB that triggers a dual TCI activation associated with the first antenna panel and the second antenna panel (e.g., a TCI 1 for the first antenna panel, and a TCI 2 for the second antenna panel). In some cases, the dual TCI activation may more generally be a multiple TCI activation, associated with two or more antenna panels of the UE.

At 304, the method 300 may include decoding the MAC-CE.

At 306, the method 300 may include, for a predetermined period of time, using a current TCI to receive over the air using at least the first antenna panel or the second antenna panel. In some embodiments, the predetermined period of time may be a predetermined period of time following a completion of the decode of the MAC-CE. The current TCI may be a TCI associated with a single antenna panel or multiple antenna panels (e.g., two or more antenna panels).

At 308, and after the predetermined period of time, the method 300 may include switching to a dual TCI activated by the dual TCI activation. The dual TCI may be used by the UE to receive, over the air, using the first antenna panel and the second antenna panel (e.g., from a first TRP and a second TRP). In some cases, the UE may prepare for the switch to the dual TCI by performing operations such as: powering ON or fully powering ON an inactive antenna panel or panels required by the dual TCI; powering OFF partially powering OFF an antenna panel or panels not required by the dual TCI; performing measurements on one or more reference signals for one or more antenna panels; determining which Rx beams to use to receive from a first TRP with the first antenna panel and/or from a second TRP with the second antenna panel; adjusting one or more antenna panels to form the Rx beams; and so on. In some cases, the entirety of the preparation may be performed after the predetermined period of time has expired. In some cases, the preparation may begin before the predetermined period of time has expired and continue after the predetermined period of time has expired. In some cases, the preparation may begin and finish before the predetermined period of time has expired. In cases where the preparation time begins or extends after the predetermined period of time, and the switch to the dual TCI is not completed until after a delay following the predetermined period of time, the network may refrain from scheduling or transmitting to the UE during the delay (e.g., because, during the delay period, the UE is in the process of preparing for its switch to the dual TCI and is unable to receive using the previous TCI (referred to at 306 as the current TCI) or the dual TCI).

Knowledge of the predetermined period of time—by specification or configuration—allows the network to schedule and transmit to the UE during the predetermined period of time, using the current TCI, knowing that the UE should be able to receive the network's transmission(s); and allows the network to refrain from scheduling or transmitting to the UE using the current TCI after the predetermined period of time, when the UE will not be able to receive the network's transmission(s).

The method 300 may be variously embodied, extended, or adapted, as described in the following paragraphs and elsewhere in this description.

In some embodiments of the method 300, the predetermined period of time may be based on the decode of the MAC-CE. For example, the predetermined period of time may extend from a completion of the decode of the MAC-CE (e.g., from a slot n in which the decode of the MAC-CE is completed). In some cases, the predetermined period of time may be T_{HARQ}+3 milliseconds (ms). T_{HARQ} is a timing between a receipt of a downlink data transmission including the MAC-CE and a transmission of an acknowledgement of the downlink data transmission (e.g., the T_{HARQ} specified in 3GPP TS 38.213 V17.6.0 (2023 June)). In these embodiments, the predetermined period of time is determined in a “count forward” manner.

In some embodiments of the method 300, the predetermined period of time may be based on an arrival time of a first L1-RSRP measurement resource after the decode of the MAC-CE. The first L1-RSRP measurement resource may be, for example, a Synchronization Signal Block (SSB) or a Channel State Information (CSI) Reference Signal (CSI-RS) (e.g., an SSB or CSI-RS transmitted by a TRP associated with the dual TCI activation (e.g., the first TRP or the second TRP)). In some embodiments, the predetermined period of time may extend from a completion of the decode of the MAC-CE (e.g., from a slot n in which the decode of the MAC-CE is completed) to a beginning of a time interval that immediately precedes the arrival time of the first L1-RSRP measurement resource. For example, the predetermined period of time may extend from a completion of the decode of the MAC-CE, a beginning of a time interval starting X time units, subframes, or subframe parts (e.g., slots) before the arrival time of the first L1-RSRP measurement resource. In some cases, the X time units may be 250 microseconds (μs). In these embodiments, the predetermined period of time is determined in a “count back” manner.

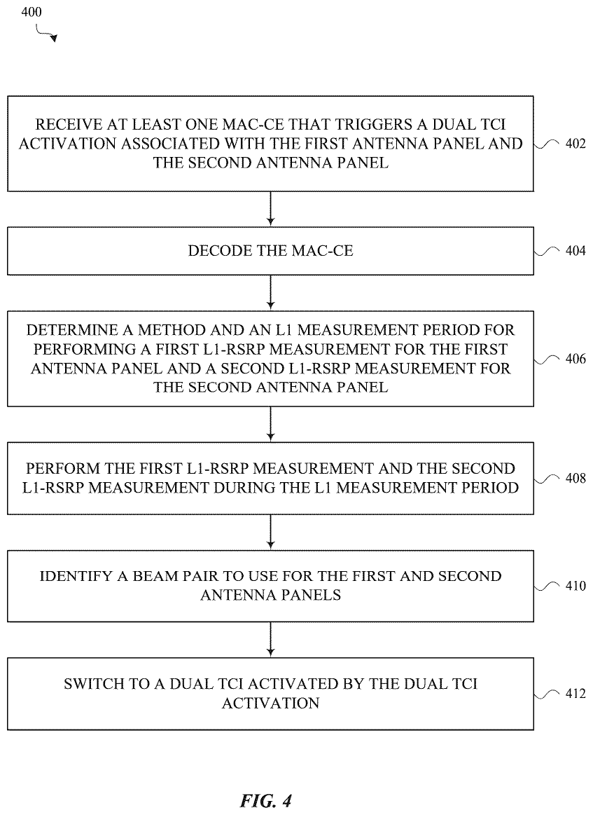

In regard to how a UE should perform any L1-RSRP measurements that may be needed before switching to a dual TCI activated by a dual TCI activation, FIG. 4 shows a method 400 that may be used by a UE to perform L1-RSRP measurements for a dual TCI activation. The method described with reference to FIG. 4 may be used, in particular, and by way of example, when the UE has not performed L1-RSRP measurements for a TRP associated with a dual TCI activation (e.g., for an unknown TCI state), or when the UE has performed L1-RSRP measurements for a TRP associated with a dual TCI activation but the L1-RSRP measurements are out-of-date or no longer valid.

FIG. 4 shows an example method 400 of wireless communication by a UE. In some cases, the UE may be the UE described with reference to FIG. 1 or 2 or one of the other UEs described herein. The method 400 may be performed using a processor, a set of one or more transceivers, and/or other components of the UE. The set of one or more transceivers may be configured to transmit and receive over the air using at least one of a first antenna panel of the UE or a second antenna panel of the UE.

At 402, the method 400 may include receiving (e.g., from a network, such as a RAN) at least one MAC-CE that triggers a dual TCI activation associated with the first antenna panel and the second antenna panel (e.g., a TCI 1 for the first antenna panel, and a TCI 2 for the second antenna panel). In some cases, the dual TCI activation may more generally be a multiple TCI activation, associated with two or more antenna panels of the UE.

At 404, the method 400 may include decoding the MAC-CE.

At 406, the method 400 may include determining a method and an L1 measurement period for performing a first L1-RSRP measurement for the first antenna panel and a second L1-RSRP measurement for the second antenna panel. The method may include, for example, performing a sweep of a first number of m receive (Rx) beams for the first antenna panel, followed by performing a sweep of a second number of n Rx beams for the second antenna panel (i.e., a sequential sweep of m Rx beams then n Rx beams). Alternatively, the method may include, for example, performing an at least partially parallel sweep of the m Rx beams for the first antenna panel and the n Rx beams for the second antenna panel (i.e., an at least partially parallel sweep of m Rx beams and n Rx beams). The numbers of Rx beams, m and n, may be the same or different. The L1 measurement period may be based on the first number of m Rx beams to be swept for the first antenna panel, the second number of n Rx beams to be swept for the second antenna panel, the first L1-RSRP measurement for the first antenna panel, and the second L1-RSRP measurement for the second antenna panel.

At 408, the method 400 may include performing the first L1-RSRP measurement and the second L1-RSRP measurement during the L1 measurement period. The first L1-RSRP measurement may be performed on a first reference signal (RS) while sweeping through the m Rx beams, and the second L1-RSRP measurement may be performed on a second RS while sweeping through the n Rx beams. The first TCI may be quasi co-located (QCL'd) with the first RS, and the second TCI may be QCL'd with the second RS.

At 410, the method 400 may include identifying a beam pair to use for the first and second antenna panels. The beam pair may be identified, at least in part, using the first and second L1-RSRP measurements.

At 412, the method 400 may include switching to a dual TCI activated by the dual TCI activation. The dual TCI may be used by the UE to receive, over the air and using the identified beam pair, using the first antenna panel and the second antenna panel (e.g., from a first TRP and a second TRP).

The method 400 may be variously embodied, extended, or adapted, as described in the following paragraphs and elsewhere in this description.

In some embodiments of the method 400, both the first L1-RSRP measurement for the first antenna panel and the second L1-RSRP measurement for the second antenna panel may be based on an SSB (i.e., each of the first RS and the second RS may be an SSB). In these embodiments, the UE may perform a respective Rx beam sweep for the SSB, using each of the first antenna panel and the second antenna panel (to make the respective first and second L1-RSRP measurements), and the UE may determine what Rx beam pair will be used for the dual TCI activation. The Rx beam pair may include a first Rx beam for the first antenna panel and a second Rx beam for the second antenna panel. In some cases, a best overall Rx beam pair may be selected, which may or may not include the best Rx beam identified in either Rx beam sweep. For example, Rx Beam A may be identified as the best Rx beam for the first antenna panel; Rx Beam B may be identified as the Rx beam for the second antenna panel; but Rx Beam A for the first antenna panel and Rx Beam D for the second antenna panel (or Rx Beam C for the first antenna panel and Rx Beam D for the second antenna panel) may be identified as the best Rx beam pair because of interference between Rx Beam A and Rx Beam B when they are used simultaneously. In some cases, a best Rx beam may be selected for one of the antenna panels, and a best complimentary Rx beam may be selected for the other antenna panel. For embodiments in which both the first and second L1-RSRP measurements are based on an SSB, the L1 measurement period may be either of:

$$( m + n ) * SSB periodicity$$

$$or$$

$$max ( m , n ) * SSB periodicity$$

where “max” is a mathematical maximum function. The first equation implies that the first and second L1-RSRP measurements are performed sequentially, using the first antenna panel and then the second antenna panel. The second equation implies that the first and second L1-RSRP measurements are performed jointly, in an interleaved manner, using the first antenna panel and the second antenna panel. Regardless of whether the first and second L1-RSRP measurements are based on the same SSB or different SSBs (e.g., SSB 1 and SSB 2), the SSBs will have the same SSB periodicity and may be time domain multiplexed when the SSBs are associated with different TRPs of a single cell (e.g., the SSBs may be include in the same SSB burst).

In some embodiments of the method 400, the first L1-RSRP measurement for the first antenna panel may be based on an SSB, and the second L1-RSRP for the second antenna panel may be based on a CSI-RS (i.e., the first RS may be an SSB, and the second RS may be a CSI-RS). In these embodiments, the UE may perform a Rx beam sweep for the SSB using the first antenna panel, and perform a Rx beam sweep for the CSI-RS using the second antenna panel (to make the respective first and second L1-RSRP measurements), and the UE may determine what Rx beam pair will be used for the dual TCI activation. The Rx beam pair may include a first Rx beam for the first antenna panel and a second Rx beam for the second antenna panel. In some cases, a best overall Rx beam pair may be selected, which may or may not include the best Rx beam identified in either Rx beam sweep. In some cases, a best Rx beam may be selected for one of the antenna panels, and a best complimentary Rx beam may be selected for the other antenna panel. For embodiments in which the first L1-RSRP measurement is based on an SSB and the second L1-RSRP measurement is based on a CSI-RS, the L1 measurement period may be either of:

$$( m + n ) * max ( CSI - RS periodicty , SSB periodicity )$$

$$or$$

$$max ( m , n ) * max ( CSI - RS periodicity , SSB periodicity )$$

The first equation implies that the first and second L1-RSRP measurements are performed sequentially, using the first antenna panel and then the second antenna panel. The second equation implies that the first and second L1-RSRP measurements are performed jointly, in an interleaved manner, using the first antenna panel and the second antenna panel.

If multiple CSI-RS resources, such as x CSI-RS resources, are provided in a CSI-RS resource set, then the above equations may be modified to:

$$( m + n ) * SSB periodicity + ceiling ( ( m + n ) / x ) * CSI - RS periodicity$$

$$or$$

$$max \{ ( m + n ) * SSB periodicity , ceiling ( ( m + n ) / x ) * CSI - RS periodicty \}$$

In some embodiments of the method 400, the first L1-RSRP measurement for the first antenna panel may be based on a first CSI-RS (e.g., CSI-RS 1), and the second L1-RSRP for the second antenna panel may be based on a second CSI-RS (e.g., CSI-RS 2) (i.e., each of the first RS and the second RS may be a respective CSI-RS). In these embodiments, the UE may perform a Rx beam sweep for the first CSI-RS using the first antenna panel, and perform a Rx beam sweep for the second CSI-RS using the second antenna panel (to make the respective first and second L1-RSRP measurements), and the UE may determine what Rx beam pair will be used for the dual TCI activation. The Rx beam pair may include a first Rx beam for the first antenna panel and a second Rx beam for the second antenna panel. In some cases, a best overall Rx beam pair may be selected, which may or may not include the best Rx beam identified in either Rx beam sweep. In some cases, a best Rx beam may be selected for one of the antenna panels, and a best complimentary Rx beam may be selected for the other antenna panel. For embodiments in which the first L1-RSRP measurement is based on a first CSI-RS and the second L1-RSRP measurement is based on a second CSI-RS, the L1 measurement period may be either of:

$$( m + n ) * max ( CSI - RS 1 periodicty , CSI - RS 2 periodicity )$$

$$or$$

$$max ( m , n ) * max ( CSI - RS 1 periodicity , CSI - RS 2 periodicity )$$

The first equation implies that the first and second L1-RSRP measurements are performed sequentially, using the first antenna panel and then the second antenna panel. The second equation implies that the first and second L1-RSRP measurements are performed jointly, in an interleaved manner, using the first antenna panel and the second antenna panel.

If multiple CSI-RS resources are provided in each of first and second CSI-RS resource sets, such as x CSI-RS resources in a CSI-RS 1 set and y CSI-RS resources in a CSI-RS 2 set, then the above equations may be modified to:

$$( m + n ) * CSI - RS 1 set periodicity + ceiling ( ( m + n ) / x ) * CSI - RS 2 set periodicity$$

$$or$$

$$max \{ ceiling ( ( m + n ) / x ) * CSI - RS 1 set periodicity , \\ ceiling ( ( m + n ) / x ) * CSI - RS 2 set periodicty \}$$

The UE may determine whether each of the first and second L1-RSRP measurements will be based on an SSB or a CSI-RS in response to radio resource control (RRC) signaling received from a network during TCI configuration (prior to the UE's receipt of the MAC-CE that triggers a dual TCI activation).

The method 400 is especially useful if one or more TCI states associated with a dual TCI activation are unknown (e.g., have not been measured by the UE) or have not been measured recently (e.g., have been measured previously but are associated with out-of-date measurements). However, the method 400 may in some cases be performed regardless of whether the TCI states associated with a dual TCI activation are known. In some embodiments, the method 400 may be combined with the method 300 and/or 500.

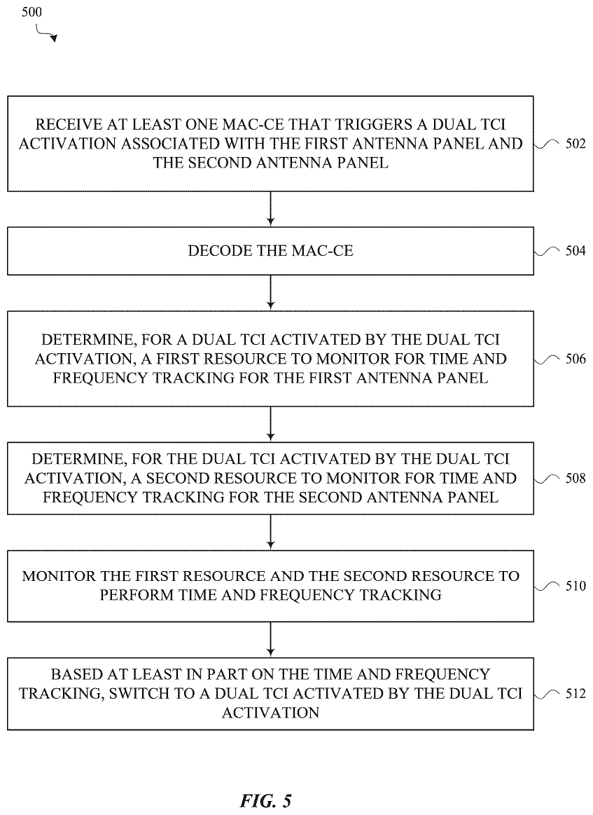

In regard to what reference signal(s) should be used by a UE for time and frequency tracking before switching to a dual TCI activated by a dual TCI activation, FIG. 5 shows a method 500 that may be used by a UE to perform time and frequency tracking. The method described with reference to FIG. 4 may be used, in particular, and by way of example, when the UE has not performed L1-RSRP measurements for a TRP associated with a dual TCI activation.

FIG. 5 shows an example method 500 of wireless communication by a UE. In some cases, the UE may be the UE described with reference to FIG. 1 or 2 or one of the other UEs described herein. The method 500 may be performed using a processor, a set of one or more transceivers, and/or other components of the UE. The set of one or more transceivers may be configured to transmit and receive over the air using at least one of a first antenna panel of the UE or a second antenna panel of the UE.

At 502, the method 500 may include receiving (e.g., from a network, such as a RAN) at least one MAC-CE that triggers a dual TCI activation associated with the first antenna panel and the second antenna panel (e.g., a TCI 1 for the first antenna panel, and a TCI 2 for the second antenna panel). In some cases, the dual TCI activation may more generally be a multiple TCI activation, associated with two or more antenna panels of the UE.

At 504, the method 500 may include decoding the MAC-CE.

At 506, the method 500 may include determining, for a dual TCI activated by the dual TCI activation, a first resource to monitor for time and frequency tracking for the first antenna panel.

At 508, the method 500 may include determining, for the dual TCI activated by the dual TCI activation, a second resource to monitor for time and frequency tracking for the second antenna panel.

At 510, the method 500 may include monitoring the first resource and the second resource to perform time and frequency tracking.

At 512, and based at least in part on the time and frequency tracking performed at 512, the method 500 may include switching to a dual TCI activated by the dual TCI activation. The dual TCI may be used by the UE to receive, over the air, using the first antenna panel and the second antenna panel (e.g., from a first TRP and a second TRP).

The method 500 may be variously embodied, extended, or adapted, as described in the following paragraphs and elsewhere in this description.

In some embodiments of the method 500, the first resource may be a first SSB and the second resource may be a second SSB. The first TCI may be QCL'd with the first SSB, and the second TCI may be QCL'd with the second SSB. An application time for the dual TCI may be based at least in part on a transmission time of a last transmitted SSB of the first SSB and the second SSB, in combination with an SSB processing time. For example, the application time may be based at least in part on:

$$TOuk * ( {T}_{last - SSB} + {T}_{SSB - proc} ) / NR slot length$$

where TOuk is defined in 3GPP TS 38.133 V18.2.0 (2023 June); T_{last-SSB} is the transmission time of the last transmitted SSB of the first SSB and the second SSB; and T_{SSB-proc} is the SSB processing time.

In some embodiments of the method 500, both the first resource and the second resource may be the same SSB. When the dual TCI (or each of the first TRP and the second TRP) is associated with a single cell, the UE may monitor the SSB that is used to determine cell-specific timing for the cell. This SSB is usually the SSB that is best received by the UE and provides the most accurate time and frequency tracking for the UE. Although the time and frequency parameters for the first TRP and the second TRP may differ from the cell-specific timing, the difference should be negligible and monitoring of the SSB that is used to determine cell-specific timing may be sufficient.

In some embodiments of the method 500, the first resource may be a first Tracking Reference Signal (TRS) and the second resource may be a second TRS. The first TCI may be QCL'd with the first TRS, and the second TCI may be QCL'd with the second TRS. An application time for the dual TCI may be based at least in part on a transmission time of a last transmitted TRS of the first TRS and the second TRS, in combination with a TRS processing time. For example, the application time may be based at least in part on:

$$TOuk * ( {T}_{last - TRS} + {T}_{TRS - proc} ) / NR slot length$$

where TOuk is defined in 3GPP TS 38.133 V18.2.0 (2023 June); T_{last-TRS} is the transmission time of the last transmitted TRS of the first TRS and the second TRS; and T_{TRS-proc} is the TRS processing time. In some embodiments, the first TRS may be a first CSI-RS and the second TRS may be a second CSI-RS. In some embodiments, the first TRS may be an SSB and the second TRS may be a CSI-RS. In some embodiments, the first TRS may be a first SSB and the second TRS may be a second SSB.

In some embodiments, the method 500 may be combined with the method 300 and/or 400.

Embodiments contemplated herein include one or more non-transitory computer-readable media storing instructions to cause an electronic device, upon execution of the instructions by one or more processors of the electronic device, to perform one or more elements of the method 300, 400, or 500. In the context of method 300, 400, or 500, this non-transitory computer-readable media may be, for example, a memory of a UE (such as a memory 706 of a wireless device 702 that is a UE, as described herein).

Embodiments contemplated herein include an apparatus having logic, modules, or circuitry to perform one or more elements of the method 300, 400, or 500. In the context of method 300, 400, or 500, this apparatus may be, for example, an apparatus of a UE (such as a wireless device 702 that is a UE, as described herein).

Embodiments contemplated herein include an apparatus having one or more processors and one or more computer-readable media, using or storing instructions that, when executed by the one or more processors, cause the one or more processors to perform one or more elements of the method 300, 400, or 500. In the context of method 300, 400, or 500, this apparatus may be, for example, an apparatus of a UE (such as a wireless device 702 that is a UE, as described herein).

Embodiments contemplated herein include a signal as described in or related to one or more elements of the method 300, 400, or 500.

Embodiments contemplated herein include a computer program or computer program product having instructions, wherein execution of the program by a processor causes the processor to carry out one or more elements of the method 300, 400, or 500. In the context of method 300, 400, or 500, the processor may be a processor of a UE (such as a processor(s) 704 of a wireless device 702 that is a UE, as described herein), and the instructions may be, for example, located in the processor and/or on a memory of the UE (such as a memory 706 of a wireless device 702 that is a UE, as described herein).

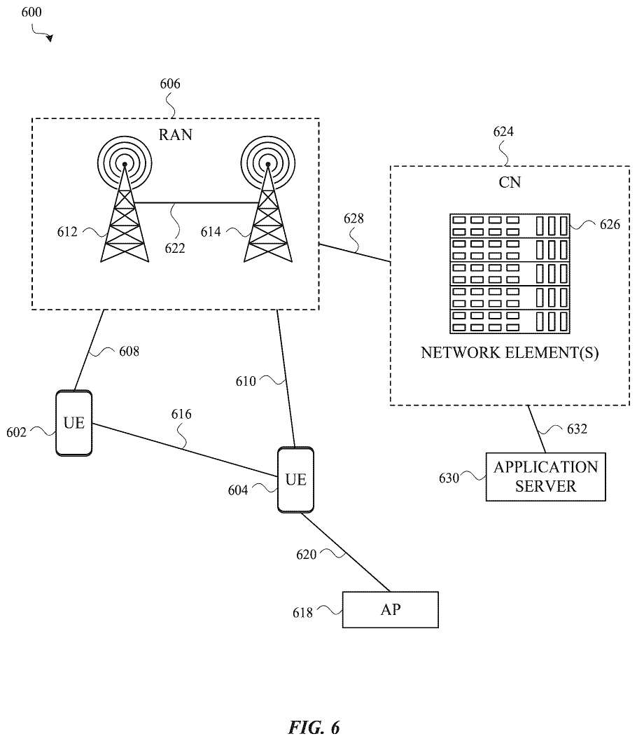

FIG. 6 illustrates an example architecture of a wireless communication system, according to embodiments described herein. The following description is provided for an example wireless communication system 600 that operates in conjunction with the LTE system standards or specifications and/or 5G or NR system standards or specifications, as provided by 3GPP technical specifications.

As shown by FIG. 6, the wireless communication system 600 includes UE 602 and UE 604 (although any number of UEs may be used). In this example, the UE 602 and the UE 604 are illustrated as smartphones (e.g., handheld touchscreen mobile computing devices connectable to one or more cellular networks), but may also comprise any mobile or non-mobile computing device configured for wireless communication.

The UE 602 and UE 604 may be configured to communicatively couple with a RAN 606. In embodiments, the RAN 606 may be NG-RAN, E-UTRAN, etc. The UE 602 and UE 604 utilize connections (or channels) (shown as connection 608 and connection 610, respectively) with the RAN 606, each of which comprises a physical communications interface. The RAN 606 can include one or more network devices, such as base station 612 and base station 614, that enable the connection 608 and connection 610.

In this example, the connection 608 and connection 610 are air interfaces to enable such communicative coupling, and may be consistent with RAT(s) used by the RAN 606, such as, for example, an LTE and/or NR.

In some embodiments, the UE 602 and UE 604 may also directly exchange communication data via a sidelink interface 616. The UE 604 is shown to be configured to access an access point (shown as AP 618) via connection 620. By way of example, the connection 620 can comprise a local wireless connection, such as a connection consistent with any IEEE 802.11 protocol, wherein the AP 618 may comprise a Wi-Fi® router. In this example, the AP 618 may be connected to another network (for example, the Internet) without going through a CN 624.

In embodiments, the UE 602 and UE 604 can be configured to communicate using orthogonal frequency division multiplexing (OFDM) communication signals with each other or with the base station 612 and/or the base station 614 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 612 or base station 614 may be implemented as one or more software entities running on server computers as part of a virtual network. In addition, or in other embodiments, the base station 612 or base station 614 may be configured to communicate with one another via interface 622. In embodiments where the wireless communication system 600 is an LTE system (e.g., when the CN 624 is an EPC), the interface 622 may be an X2 interface. The X2 interface may be defined between two or more network devices of a RAN (e.g., two or more eNBs and the like) that connect to an EPC, and/or between two eNBs connecting to the EPC. In embodiments where the wireless communication system 600 is an NR system (e.g., when CN 624 is a 5GC), the interface 622 may be an Xn interface. The Xn interface is defined between two or more network devices of a RAN (e.g., two or more gNBs and the like) that connect to the 5GC, between a base station 612 (e.g., a gNB) connecting to the 5GC and an eNB, and/or between two eNBs connecting to the 5GC (e.g., CN 624).

The RAN 606 is shown to be communicatively coupled to the CN 624. The CN 624 may comprise one or more network elements 626, which are configured to offer various data and telecommunications services to customers/subscribers (e.g., users of UE 602 and UE 604) who are connected to the CN 624 via the RAN 606. The components of the CN 624 may be implemented in one physical device or separate physical devices including components to read and execute instructions from a machine-readable or computer-readable medium (e.g., a non-transitory machine-readable storage medium).

In embodiments, the CN 624 may be an EPC, and the RAN 606 may be connected with the CN 624 via an S1 interface 628. In embodiments, the S1 interface 628 may be split into two parts, an S1 user plane (S1-U) interface, which carries traffic data between the base station 612 or base station 614 and a serving gateway (S-GW), and the S1-MME interface, which is a signaling interface between the base station 612 or base station 614 and mobility management entities (MMEs).

In embodiments, the CN 624 may be a 5GC, and the RAN 606 may be connected with the CN 624 via an NG interface 628. In embodiments, the NG interface 628 may be split into two parts, an NG user plane (NG-U) interface, which carries traffic data between the base station 612 or base station 614 and a user plane function (UPF), and the S1 control plane (NG-C) interface, which is a signaling interface between the base station 612 or base station 614 and access and mobility management functions (AMFs).

Generally, an application server 630 may be an element offering applications that use internet protocol (IP) bearer resources with the CN 624 (e.g., packet switched data services). The application server 630 can also be configured to support one or more communication services (e.g., VoIP sessions, group communication sessions, etc.) for the UE 602 and UE 604 via the CN 624. The application server 630 may communicate with the CN 624 through an IP communications interface 632.

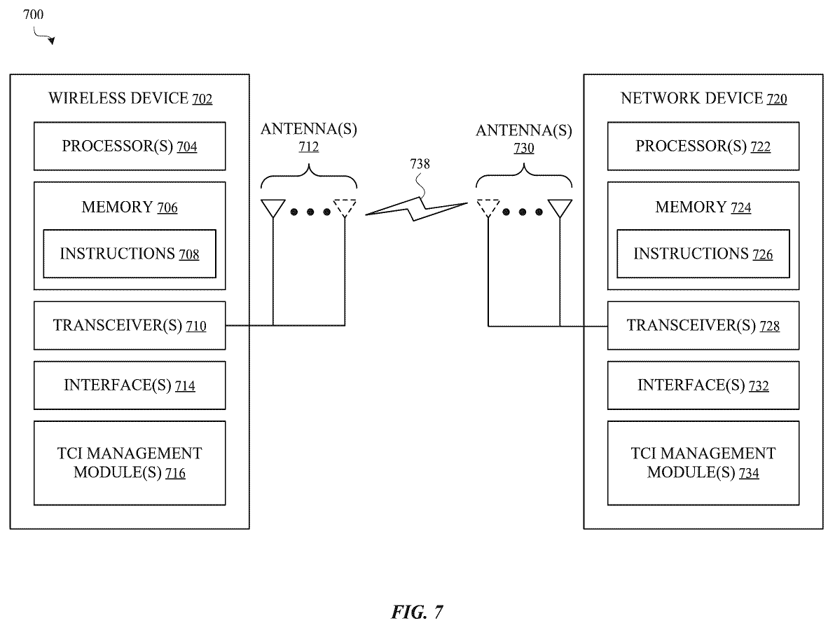

FIG. 7 illustrates an example system 700 for performing signaling 738 between a wireless device 702 and a network device 720, according to embodiments described herein. The system 700 may be a portion of a wireless communication system as herein described. The wireless device 702 may be, for example, a UE of a wireless communication system. The network device 720 may be, for example, a base station (e.g., an eNB or a gNB) or a radio head of a wireless communication system.

The wireless device 702 may include one or more processor(s) 704. The processor(s) 704 may execute instructions such that various operations of the wireless device 702 are performed, as described herein. The processor(s) 704 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 702 may include a memory 706. The memory 706 may be a non-transitory computer-readable storage medium that stores instructions 708 (which may include, for example, the instructions being executed by the processor(s) 704). The instructions 708 may also be referred to as program code or a computer program. The memory 706 may also store data used by, and results computed by, the processor(s) 704.

The wireless device 702 may include one or more transceiver(s) 710 (also collectively referred to as a transceiver 710) that may include radio frequency (RF) transmitter and/or receiver circuitry that use the antenna(s) 712 of the wireless device 702 to facilitate signaling (e.g., the signaling 738) to and/or from the wireless device 702 with other devices (e.g., the network device 720) according to corresponding RATs.

The wireless device 702 may include one or more antenna(s) 712 (e.g., one, two, four, eight, or more), distributed across two or more antenna panels. For embodiments with multiple antenna(s) 712, the wireless device 702 may leverage the spatial diversity of such multiple antenna(s) 712 to send and/or receive multiple different data streams on the same time and frequency resources. This behavior may be referred to as, for example, MIMO behavior (referring to the multiple antennas used at each of a transmitting device and a receiving device that enable this aspect). MIMO transmissions by the wireless device 702 may be accomplished according to precoding (or digital beamforming) that is applied at the wireless device 702 that multiplexes the data streams across the antenna(s) 712 according to known or assumed channel characteristics such that each data stream is received with an appropriate signal strength relative to other streams and at a desired location in the spatial domain (e.g., the location of a receiver associated with that data stream). Some embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In some embodiments having multiple antennas, the wireless device 702 may implement analog beamforming techniques, whereby phases of the signals sent by the antenna(s) 712 are relatively adjusted such that the (joint) transmission of the antenna(s) 712 can be directed (this is sometimes referred to as beam steering).

The wireless device 702 may include one or more interface(s) 714. The interface(s) 714 may be used to provide input to or output from the wireless device 702. For example, a wireless device 702 that is a UE may include interface(s) 714 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 710/antenna(s) 712 already described) that allow for communication between the UE and other devices and may operate according to known protocols (e.g., Wi-Fi®, Bluetooth®, and the like).

The wireless device 702 may include TCI management module(s) 716. The TCI management module(s) 716 may be implemented via hardware, software, or combinations thereof. For example, the TCI management module(s) 716 may be implemented as a processor, circuit, and/or instructions 708 stored in the memory 706 and executed by the processor(s) 704. In some examples, the TCI management module(s) 716 may be integrated within the processor(s) 704 and/or the transceiver(s) 710. For example, the TCI management module(s) 716 may be implemented by a combination of software components (e.g., executed by a DSP or a general processor) and hardware components (e.g., logic gates and circuitry) within the processor(s) 704 or the transceiver(s) 710.

The TCI management module(s) 716 may be used for various aspects of the present disclosure, for example, aspects of FIGS. 1-5, from a wireless device or UE perspective. The TCI management module(s) 716 may be configured to, for example, receive a MAC layer TCI activation, and make determinations and measurements related thereto, as described herein. The TCI management module(s) 716 may also cause the wireless device 702 to switch to an activated TCI (which in some cases may be a dual TCI).

The network device 720 may include one or more processor(s) 722. The processor(s) 722 may execute instructions such that various operations of the network device 720 are performed, as described herein. The processor(s) 722 may include one or more baseband processors implemented using, for example, a CPU, a DSP, an ASIC, a controller, an FPGA device, another hardware device, a firmware device, or any combination thereof configured to perform the operations described herein.

The network device 720 may include a memory 724. The memory 724 may be a non-transitory computer-readable storage medium that stores instructions 726 (which may include, for example, the instructions being executed by the processor(s) 722). The instructions 726 may also be referred to as program code or a computer program. The memory 724 may also store data used by, and results computed by, the processor(s) 722.

The network device 720 may include one or more transceiver(s) 728 (also collectively referred to as a transceiver 728) that may include RF transmitter and/or receiver circuitry that use the antenna(s) 730 of the network device 720 to facilitate signaling (e.g., the signaling 738) to and/or from the network device 720 with other devices (e.g., the wireless device 702) according to corresponding RATs.

The network device 720 may include one or more antenna(s) 730 (e.g., one, two, four, or more). In embodiments having multiple antenna(s) 730, the network device 720 may perform MIMO, digital beamforming, analog beamforming, beam steering, etc., as has been described.

The network device 720 may include one or more interface(s) 732. The interface(s) 732 may be used to provide input to or output from the network device 720. For example, a network device 720 of a RAN (e.g., a base station, a radio head, etc.) may include interface(s) 732 made up of transmitters, receivers, and other circuitry (e.g., other than the transceiver(s) 728/antenna(s) 730 already described) that enables the network device 720 to communicate with other equipment in a network, and/or that enables the network device 720 to communicate with external networks, computers, databases, and the like for purposes of operations, administration, and maintenance of the network device 720 or other equipment operably connected thereto.

The network device 720 may include one or more TCI management module(s) 734. The TCI management module(s) 734 may be implemented via hardware, software, or combinations thereof. For example, the TCI management module(s) 734 may be implemented as a processor, circuit, and/or instructions 726 stored in the memory 724 and executed by the processor(s) 722. In some examples, the TCI management module(s) 734 may be integrated within the processor(s) 722 and/or the transceiver(s) 728. For example, the TCI management module(s) 734 may be implemented by a combination of software components (e.g., executed by a DSP or a general processor) and hardware components (e.g., logic gates and circuitry) within the processor(s) 722 or the transceiver(s) 728.

The TCI management module(s) 734 may be used for various aspects of the present disclosure, for example, aspects of FIGS. 1-5, from a network device perspective. The TCI management module(s) 734 may be configured to, for example, transmit a MAC layer TCI activation to the wireless device 702 and otherwise configure one or more TCI states for the wireless device 702.

For one or more embodiments, at least one of the components set forth in one or more of the preceding figures may be configured to perform one or more operations, techniques, processes, and/or methods as set forth herein. For example, a baseband processor (or processor) as described herein in connection with one or more of the preceding figures may be configured to operate in accordance with one or more of the examples set forth herein. For another example, circuitry associated with a UE, network device, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form described. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

The systems described herein pertain to specific embodiments but are provided as examples. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1.-13. (canceled)

14. A user equipment (UE), comprising:
a first antenna panel;
a second antenna panel;
a set of one or more transceivers configured to transmit and receive over the air using at least one of the first antenna panel or the second antenna panel; and
a processor configured to,
receive at least one Medium Access Control (MAC) Control Element (CE) (MAC-CE) that triggers a dual Transmission Configuration Indicator (TCI) activation associated with the first antenna panel and the second antenna panel;
decode the MAC-CE;
determine, for a dual TCI activated by the dual TCI activation, a first resource to monitor for time and frequency tracking for the first antenna panel; and
determine, for the dual TCI activated by the dual TCI activation, a second resource to monitor for time and frequency tracking for the second antenna panel.

15. The UE of claim 14, wherein:
the first resource is a first Synchronization Signal Block (SSB); and
the second resource is a second SSB.

16. The UE of claim 14, wherein:
the first resource is a Synchronization Signal Block (SSB);
the second resource is the SSB; and
the SSB is used to determine a cell-specific timing for a cell associated with the dual TCI.

17. The UE of claim 14, wherein:
the first resource is a first Tracking Reference Signal (TRS);
the second resource is a second TRS; and
an application time for the dual TCI is based at least in part on transmission time of a last transmitted TRS of the first TRS and the second TRS, in combination with a TRS processing time.

18. (canceled)

19. (canceled)

20. The UE of claim 17, wherein:
the first TRS is a first Synchronization Signal Block (SSB); and
the second TRS is a second SSB.

21. The UE of claim 15, wherein:
an application time for the dual TCI is based at least in part on a transmission time of a last transmitted SSB of the first SSB and the second SSB, in combination with an SSB processing time.

22. The UE of claim 14, wherein the first TCI may be quasi co-located (QCL'd) with the first SSB, and the second TCI may be QCL'd with the second SSB.

23. A baseband processor comprising a memory and configured to:
receive at least one Medium Access Control (MAC) Control Element (CE) (MAC-CE) that triggers a dual Transmission Configuration Indicator (TCI) activation;
decode the MAC-CE;
determine, for a dual TCI activated by the dual TCI activation, a first resource to monitor for time and frequency tracking; and
determine, for the dual TCI activated by the dual TCI activation, a second resource to monitor for time and frequency tracking.

24. The baseband processor of claim 23, wherein:
the first resource is a first Synchronization Signal Block (SSB); and
the second resource is a second SSB.

25. The baseband processor of claim 24, wherein:
an application time for the dual TCI is based at least in part on a transmission time of a last transmitted SSB of the first SSB and the second SSB, in combination with an SSB processing time.

26. The baseband processor of claim 23, wherein the first TCI may be quasi co-located (QCL'd) with the first SSB, and the second TCI may be QCL'd with the second SSB.

27. The baseband processor of claim 23, wherein:
the first resource is a Synchronization Signal Block (SSB);
the second resource is the SSB; and
the SSB is used to determine a cell-specific timing for a cell associated with the dual TCI.

28. The baseband processor of claim 23, wherein:
the first resource is a first Tracking Reference Signal (TRS);
the second resource is a second TRS; and
an application time for the dual TCI is based at least in part on transmission time of a last transmitted TRS of the first TRS and the second TRS, in combination with a TRS processing time.

29. The baseband processor of claim 28, wherein:
the first TRS is a first Synchronization Signal Block (SSB); and
the second TRS is a second SSB.

30. A method of a user equipment (UE), comprising:
receiving at least one Medium Access Control (MAC) Control Element (CE) (MAC-CE) that triggers a dual Transmission Configuration Indicator (TCI) activation;
decoding the MAC-CE;
determining, for a dual TCI activated by the dual TCI activation, a first resource to monitor for time and frequency tracking; and
determining, for the dual TCI activated by the dual TCI activation, a second resource to monitor for time and frequency tracking.

31. The method of claim 30, wherein:
the first resource is a first Synchronization Signal Block (SSB); and
the second resource is a second SSB.

32. The method of claim 31, wherein:
an application time for the dual TCI is based at least in part on a transmission time of a last transmitted SSB of the first SSB and the second SSB, in combination with an SSB processing time.

33. The method of claim 30, wherein the first TCI may be quasi co-located (QCL'd) with the first SSB, and the second TCI may be QCL'd with the second SSB.

34. The method of claim 30, wherein:
the first resource is a first Tracking Reference Signal (TRS);
the second resource is a second TRS; and
an application time for the dual TCI is based at least in part on transmission time of a last transmitted TRS of the first TRS and the second TRS, in combination with a TRS processing time.

35. The method of claim 34, wherein:
the first TRS is a first Synchronization Signal Block (SSB); and
the second TRS is a second SSB.
